(19) United States
(12) Patent Application Publication
(10) Pub. No.: US 2012/0131493 A1
(43) Pub. Date: May 24, 2012

(54) COMPUTER INFORMATION DISPLAY METHOD AND COMPUTER SYSTEM USING THE SAME

(75) Inventors: Yu-Ting Lai, Taipei City (TW); Yi-Chang Chen, Taipei City (TW); Chih-Chien Liu, Taipei City (TW); Chih-Hsing Kang, Taipei City (TW)

(73) Assignee: COMPAL ELECTRONICS, INC., Taipei City (TW)

(21) Appl. No.: 13/297,278

(22) Filed: Nov. 16, 2011

Related U.S. Application Data
(60) Provisional application No. 61/414,407, filed on Nov. 16, 2010.

(51) Int. Cl. G06F 3/048

(52) U.S. Cl. 715/780

(57) ABSTRACT

A computer system and a computer information display method thereof are provided. In the method, a computer information management unit stores computer information of an application program in a storage unit. During a system login process of the computer system, a processing unit reads the computer information form the storage unit, and displays the computer information and a login dialog on a screen unit.

### CROSS-REFERENCE TO RELATED APPLICATION

This application claims the priority benefit of U.S. Provisional Application Ser. No. 61/414,407, filed Nov. 16, 2010. The entirety of the above-mentioned patent application is hereby incorporated by reference herein and made a part of this specification.

### BACKGROUND OF THE INVENTION

1. Field of the Invention

The invention relates to a computer system. Particularly, the invention relates to a computer system capable of displaying information related to an application program before a user actually logs in the computer system and a computer information display method thereof.

2. Description of Related Art

Along with development of technology, popularisation of computer systems is gradually increased. Modern people are used to use the computer systems as tools in office routine, learning, communication, information browsing and entertainment. Besides using the powerful computing capability of the computer systems, the modern people also store important data in the computer systems.

Since data stored in the computer system is easy to be copied to storage devices such as flash drives, etc., and is easy to be leaked out through a network, in order to ensure security of the personal data stored in the computer system, a user generally sets a password for the computer system. Therefore, each time when the computer system is used, a correct account number and the password have to be input for login, so as to prevent others from arbitrarily logging in to peek data stored in the computer system.

In other words, once the computer system is set with the password, regardless of whether the user wants to turn on the computer system, to wake up the computer system from a sleeping mode, or to leave a screensaver, the correct account number and the password have to be input in order to log in the computer system. Therefore, even if the user only wants to quickly browse states or information of some application programs in the computer system without actually using these application programs, the user has to log in the computer system and then launches these application programs. The above operation manner is inconvenient to the user.

### SUMMARY OF THE INVENTION

The invention is directed to a computer information display method and a computer system, by which before a user actually logs in the computer system, information of a part of application programs is displayed.

The invention provides a computer information display method, which is adapted to a computer system about to resume to a working mode, where the computer system includes a storage unit, a computer information management unit, a processing unit and a screen unit. In the method, the computer information management unit stores computer information of an application program in the storage unit. During a system login process, the processing unit reads the computer information, and displays the computer information and a login dialog on the screen unit.

In an embodiment of the invention, the system login process is performed when the computer system enters from a power-off mode, resumes from a sleeping mode, or enters from a screen saver mode.

In an embodiment of the invention, the computer information is comprised of one of email information, schedule information, weather information, and multimedia file information, or a combination thereof.

In an embodiment of the invention, the computer information management unit stores the computer information of the application program in the storage unit before the computer system enters the power-off mode, the sleeping mode or the screen saver mode.

In an embodiment of the invention, the processing unit displays an information display frame on the screen unit, where the information display frame comprises the computer information and the login dialog.

In an embodiment of the invention, the login dialog comprises a password dialog.

In an embodiment of the invention, the processing unit displays a system login frame after displaying the information display frame on the screen unit, where the information display frame comprises the computer information, and the system login frame comprises the login dialog.

In an embodiment of the invention, the computer information management unit provides a user interface for selecting the application program and setting public content of the related computer information to be displayed.

In an embodiment of the invention, the system login frame further includes a logout dialog, and when the logout dialog is selected, the processing unit displays the information display frame on the screen unit.

In an embodiment of the invention, when the computer system is connected to a network, the computer information management unit updates the computer information of the application program.

According to another aspect, the invention provides a computer system including a storage unit, a computer information management unit, a processing unit and a screen unit. The storage unit stores an application program. The computer information management unit collects computer information of the application program and stores the computer information in the storage unit. During a system login process of the computer system, the processing unit reads the computer information from the storage unit, and displays the computer information and a login dialog on the screen unit.

According to the above descriptions, in the computer system and the computer information display method of the invention, during a process that the computer system enters from the power-off mode, resumes from the sleeping mode, enters from the screen saver mode, the information display frame is first displayed to present the computer information of the application program, so that the user can directly browse the related information of the application program that can be executed by the computer system via the information display frame without completing the system login process and starting the application program. In this way, convenience for browsing the computer information of the application program is improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a computer system according to an embodiment of the invention.

FIG. 2 is a flowchart illustrating a computer information display method according to an embodiment of the invention.

FIG. 3 is a schematic diagram of an information display frame according to an embodiment of the invention.

FIG. 4 is a flowchart illustrating a computer information display method according to another embodiment of the invention.

FIG. 5 is a schematic diagram of a system login frame according to another embodiment of the invention.

### DETAILED DESCRIPTION OF DISCLOSED EMBODIMENTS

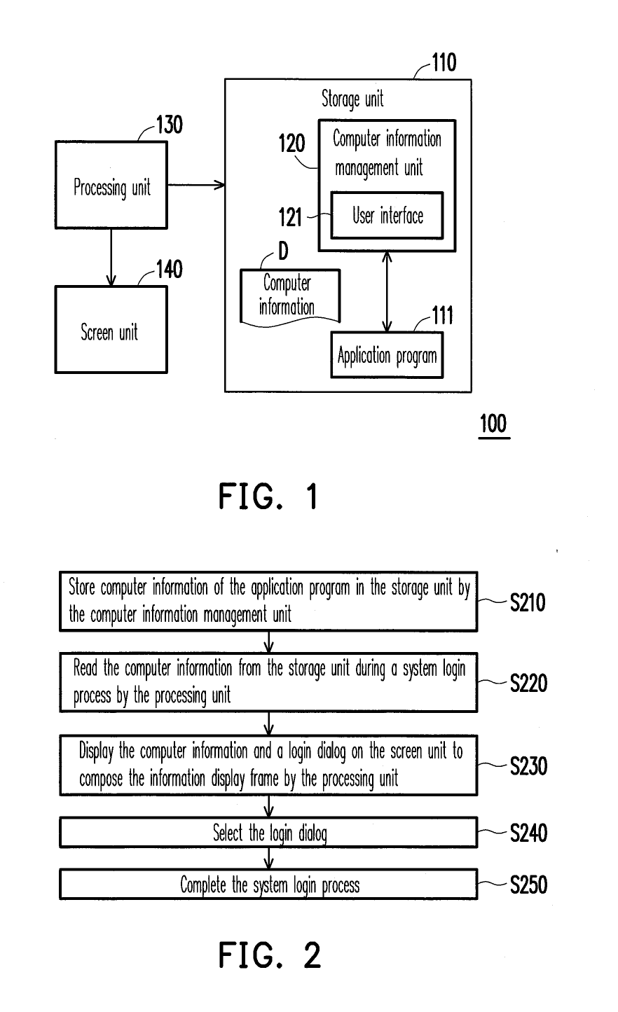

FIG. 1 is a block diagram of a computer system 100 according to an embodiment of the invention. Referring to FIG. 1, the computer system 100 includes a storage unit 110, a computer information management unit 120, a processing unit 130 and a screen unit 140. The computer system 100 may be a desktop computer system, a laptop computer, a tablet computer, a work station or a server, etc., which is not limited by the invention.

The storage unit 110 may be a storage device built in the computer system 100 such as a hard disk or a memory (for example, a flash memory), etc. Alternatively, the storage unit 110 may be an external storage device such as a flash drive or a memory card, etc. Moreover, the storage unit 110 stores a plurality of application programs (for example, the application program 111 in FIG. 1). In the present embodiment, the application program 111 may be an email program (for example, the Microsoft Outlook application), a weather program, a to-do list program, a calendar program, a schedule program or a multimedia file program, etc.

The computer information management unit 120 stores computer information D of the application program 111 into the storage unit 110. The computer information management unit 120 collects and stores the computer information D of the application program 111 before the computer system 100 enters a power-off mode, a sleeping mode or a screen saver mode.

Moreover, the computer information D is, for example, information generated while executing the application information 111, or information related to an execution state of the application program 111. For instance, the computer information D may be comprised of one of email information (for example, the number of unread emails, email subjects, senders, or sending dates, etc.), schedule information (for example, date and time and/or location of a working meeting or a private gathering, or tasks to be done), weather information, and multimedia file information (for example, a playing progress of a movie or photos or an executing state of a game), or a combination thereof.

The processing unit 130 executes a system login process of the computer system 100. For example, when the computer system 100 operates, it complies with an advanced configuration and power interface (ACPI) specification, and when the computer system 100 is in the power-off mode (e.g., the G2 or G3 mode of the ACPI specification), the sleeping mode (e.g., the G1 mode of the ACPI specification), or a screen saver mode (i.e., the screen saver program of the computer system 100 is active), the user may input a system login command, so that the processing unit 130 executes the system login process to resume the computer system 100 back to the working mode (i.e. the G0 mode of the ACPI specification).

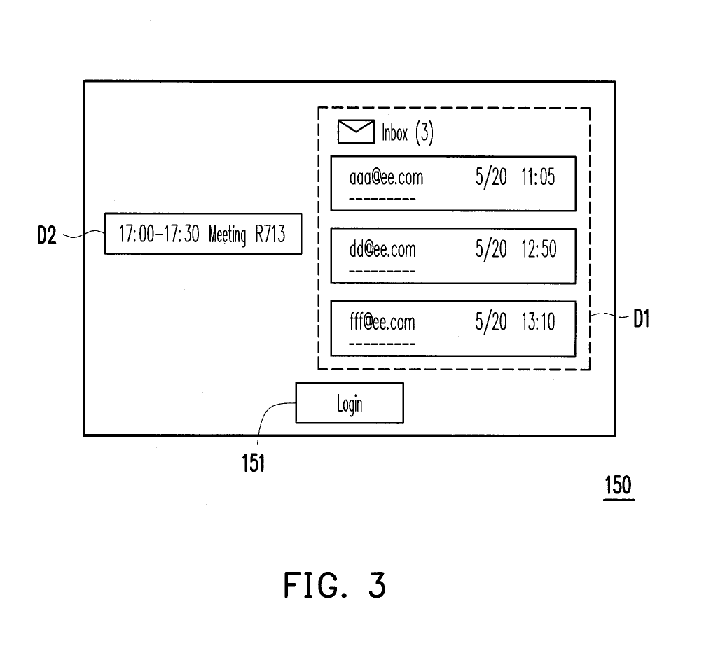

In the present embodiment, during the system login process of the computer system 100, the processing unit 130 reads the computer information from the storage unit 110, and displays the computer information on the screen unit 140 to compose an information display frame 150 (shown in FIG. 3). The screen unit 140 is, for example, a liquid crystal screen, a resistive touch screen, or a capacitive touch screen, etc., which is used to display various operation frames of the computer system 100.

In this way, it is unnecessary to launch the application program 111 before completing the system login process of the computer system 100, and the computer information management unit 120 can obtain the computer information D of the application program 111 to get the information or state of the application program 111.

Detailed operations of each of the components of the computer system 100 are described below. FIG. 2 is a flowchart illustrating a computer information display method according to an embodiment of the invention. Referring to FIG. 1, FIG. 2 and FIG. 3, in the present embodiment, the computer system 100 is about to resume from the power-off mode.

First, in step S210, when the computer system 100 is turned off last time, the computer information management unit 120 stores the computer information D of the application program 111 in the storage unit 110. In the present embodiment, the computer information management unit 120 obtains the related computer information D from an email program and a schedule program.

Moreover, the computer information management unit 120 further provides a user interface 121, and the user can determine the non-user specific content of the application program 111 through the user interface 121. To be specific, through the user interface 121, the user can select the application program 111 from all application programs stored in the storage unit 110, and then set public content of the computer information D related to the application program 111 that can be displayed in the information display frame 150. According to the setting made by the user, the computer information management unit 120 identifies which application program that the information thereof is accessible (i.e., the computer information D), and the specific content of the computer information D that can be displayed (which is denoted as the public content). In the present embodiment, the computer information D set by the user through the user interface 121 are, for example, the information related to the email program and the schedule program, wherein the public content D1 corresponding to the email program is the number of unread emails, subjects, senders and sending dates of the latest 3 unread emails, and the public content D2 corresponding to the calendar program is a notification of the latest meeting.

It should be noticed that each time when the computer system 100 is connected to the network, even if the computer system 100 does not complete the system login program, the computer information management unit 120 updates the computer information D via the network according to the setting related to the application program 111 made by the user through the user interface 121. Therefore, before the computer system 100 of the invention completes the system login process, the user is able to obtain the latest computer information D of the application programs 111 through the information display frame 150.

Then, in step S220, during the system login process, the processing unit 130 reads the computer information D from the storage unit 110.

Then, in step S230, the processing unit 130 displays the computer information D on the screen unit 140 to compose the information display frame 150. Therefore, as shown in FIG. 3, the information display frame 150 displayed on the screen unit 140 of the present embodiment is illustrated.

It should be noticed that the information display frame 150 of the present embodiment further includes a login dialog 151, and in step S240, when the user selects the login dialog 151, in step S250, the computer system 100 completes the system login process.

Moreover, the login dialog 151 may be a selectable button, or a password dialog to which the user has to input the correct password to complete the system login process.

It should be noted that the login dialog is not a necessity to compose the information display frame. In another embodiment, the user may input a first command (not shown) such as a signal generated by moving a mouse, pressing a specific key on a keyboard, or clicking a next button if it exists on the information display frame, and after the processing unit 130 receives the first command, the processing unit 130 continues the system login operation, and the screen unit 140 presents a desktop screen of the computer system 100.

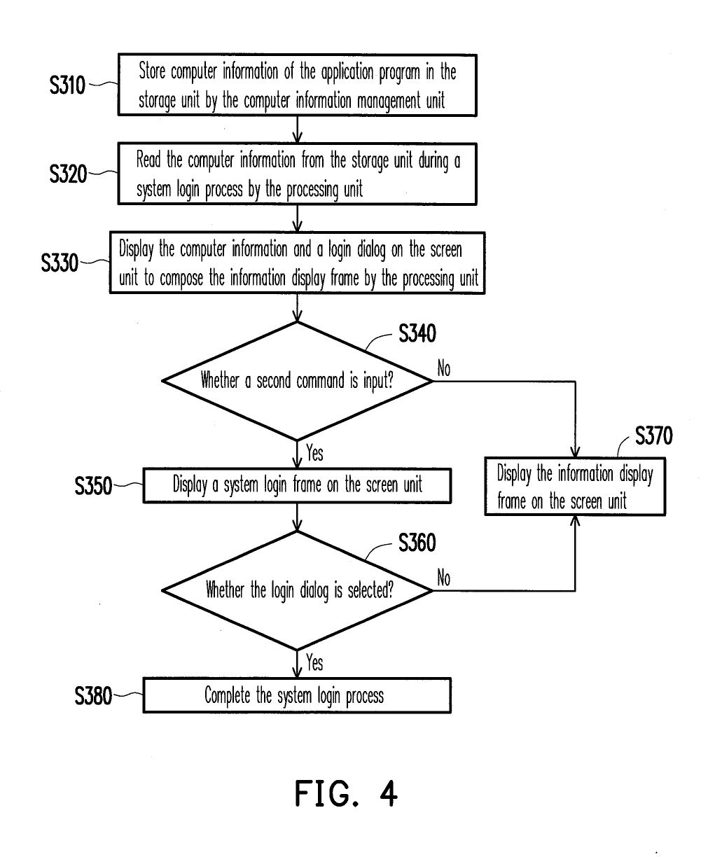

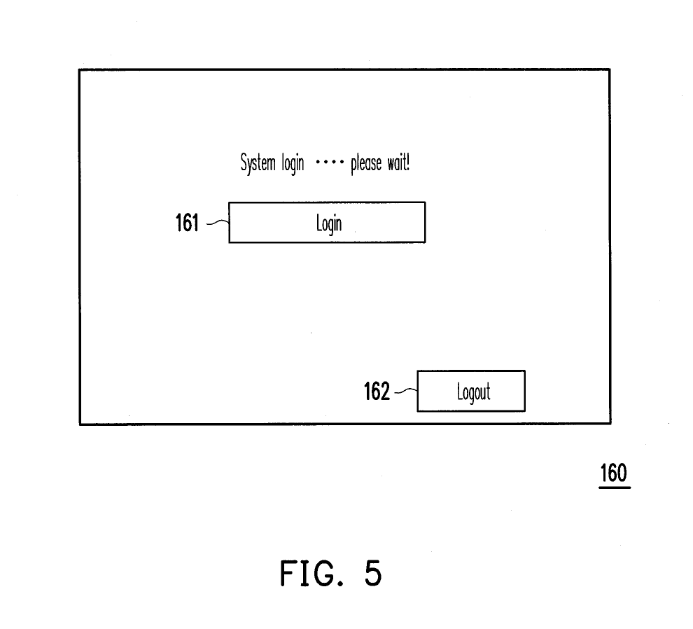

FIG. 4 is a flowchart illustrating a computer information display method according to another embodiment of the invention, in which steps S310-S330 used for displaying the information display frame are the same to the steps S210-S230 of the aforementioned embodiment, so that details thereof are not repeated. A difference of the present embodiment and the aforementioned embodiment is that the computer system 100 displays a system login frame 160 (shown in FIG. 5) after displaying the information display frame 150.

When the screen unit 140 displays the information display frame 150, in step S340, it is determined whether the user inputs a second command. The second command is, for example, a signal generated by moving the mouse, pressing a specific key on the keyboard, or clicking a next button if it exists on the information display frame.

If a determination result of the step S340 is negative, in step S370, the processing unit 130 displays the information display frame 150 on the screen unit 140.

If a determination result of the step S340 is positive, in step S350, when the processing unit 130 receives the second command, it controls the screen unit 140 to display the system login frame 160. The system login frame 160 comprises a login dialog 161, where the login dialog 161 may be a selectable button or a password dialog. Then, in step S360, it is determined whether the user selects the login dialog 161. When the user selects the login dialog 161, in step S380, the computer system 100 continues the system login process.

If the user does not select the login dialog 161 within a period of time, or the user inputs a wrong password into the password dialog, in step S370, the processing unit 130 controls the screen unit 140 to display the information display frame 150. Moreover, the system login frame 160 may further comprise a logout dialog 162, and when the user selects the logout dialog 162, the processing unit 130 controls the screen unit 140 to display the information display frame 150.

In summary, in the computer system and the computer information display method of the invention, during a process that the computer system starting from the power-off mode, resumes from the sleeping mode, enters from the screen saver mode, the information display frame is first displayed to present the computer information of certain application programs. Accordingly, the user can directly acquire the related information of the application programs that can be executed by the computer system through the information display frame before the system login process is complete and without launching the application programs. In this way, convenience for browsing the computer information of the application programs is improved. Moreover, the user also is able to further decide what kind of information can be displayed on the information display frame to further protect personal privacy.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A computer information display method, comprising:
storing computer information of an application program in a storage unit by a computer information management unit;
reading the computer information by a processing unit during a system login process; and
displaying the computer information and a login dialog on a screen unit by the processing unit.

2. The computer information display method as claimed in claim 1, wherein the system login process is performed when a computer system enters from a power-off mode, resumes from a sleeping mode, or enters from a screen saver mode.

3. The computer information display method as claimed in claim 1, wherein the computer information is comprised of one or a combination of email information, schedule information, weather information, and multimedia file information.

4. The computer information display method as claimed in claim 2, wherein the computer information management unit stores the computer information of the application program in the storage unit before the computer system enters the power-off mode, the sleeping mode or the screen saver mode.

5. The computer information display method as claimed in claim 1, wherein the processing unit displays an information display frame on the screen unit, and the information display frame comprises the computer information and the login dialog.

6. The computer information display method as claimed in claim 5, wherein the login dialog comprises a password dialog.

7. The computer information display method as claimed in claim 1, wherein the processing unit displays a system login frame after displaying the information display frame on the screen unit, wherein the information display frame comprises the computer information.

8. The computer information display method as claimed in claim 7, wherein the system login frame comprises the login dialog.

9. The computer information display method as claimed in claim 1, wherein the computer information management unit provides a user interface for selecting the application program and setting public content of the related computer information to be displayed.

10. The computer information display method as claimed in claim 7, wherein the system login frame further comprises a logout dialog, and when the logout dialog is selected, the processing unit displays the information display frame on the screen unit.

11. The computer information display method as claimed in claim 1, wherein when the computer system is connected to a network, the computer information management unit updates the computer information of the application program.

12. A computer system, comprising:
a storage unit, storing an application program;
a computer information management unit, collecting computer information of the application program for storing in the storage unit;
a processing unit, reading the computer information from the storage unit during a system login process of the computer system; and
a screen unit, wherein the processing unit displays the computer information and a login dialog on the screen unit.

13. The computer system as claimed in claim 12, wherein the system login process is performed when the computer system enters from a power-off mode, resumes from a sleeping mode, or enters from a screen saver mode.

14. The computer system as claimed in claim 12, wherein the computer information is comprised of one or a combination of email information, schedule information, weather information, and multimedia file information.

15. The computer system as claimed in claim 13, wherein the computer information management unit stores the computer information of the application program in the storage unit before the computer system enters the power-off mode, the sleeping mode or the screen saver mode.

16. The computer system as claimed in claim 12, wherein the processing unit displays an information display frame on the screen unit, and the information display frame comprises the computer information and the login dialog.

17. The computer system as claimed in claim 16, wherein the login dialog comprises a password dialog.

18. The computer system as claimed in claim 12, wherein the processing unit displays a system login frame after displaying the information display frame on the screen unit, wherein the information display frame comprises the computer information.

19. The computer system as claimed in claim 18, wherein the system login frame comprises the login dialog.

20. The computer system as claimed in claim 12, wherein the computer information management unit provides a user interface for selecting the application program and setting public content of the related computer information to be displayed.

21. The computer system as claimed in claim 12, wherein the system login frame further comprises a logout dialog, and when the logout dialog is selected, the processing unit displays the information display frame on the screen unit.

22. The computer system as claimed in claim 12, wherein when the computer system is connected to a network, the computer information management unit updates the computer information of the application program.
